(19) United States
(12) Patent Application Publication
(10) Pub. No.: US 2007/0141913 A1
(43) Pub. Date: Jun. 21, 2007

(54) Electrical contact assembly and method of manufacturing thereof

(75) Inventor: David Stanley Szczesny, Hershey, PA (US)

Correspondence Address: Robert J. Kapalka, Esq.;Tyco Electronics, c/o The Whitaker Corporation, 4550 New Linden Hill Road-Suite 150, Wilmington, DE, 19808, US

(73) Assignee: Tyco Electronics Corporation

(21) Appl. No.: 11/304,235

(22) Filed: Dec. 15, 2005

(51) Int. Cl. H01R 24/00

(52) U.S. Cl. 439/637

(57) ABSTRACT

An electrical connector assembly is disclosed which includes a housing; and a plurality of substantially identical contact assemblies each including a pair of electrical contacts with receptacle contact portions configured to be received by the housing. The plurality of contact assemblies are arranged in sequence in a linear array in the housing, and in alternating first and second orientations. The second orientation is a reverse orientation with respect to the first orientation. The substantially identical electrical contact assemblies each include a first electrical contact and a second electrical contact and a receptacle contact portion in electrical communication with the edge connector portion. The edge connector portions are substantially a mirror image while the receptacle contact portions are substantially slide-along images of each other. A method of manufacturing is also disclosed for the electrical contact assemblies.

### BACKGROUND

1. Technical Field

The present disclosure relates to electrical contact assemblies and, more particularly, to electrical contact assemblies for electrical connectors configured so as to reduce manufacturing costs.

2. Discussion of Related Art

Electrical connectors for applications such as mating to an edge of a printed circuit board must contain numerous electrical contacts. Therefore, the cost of manufacturing an electrical connector is driven by the cost of manufacturing and inserting the electrical contacts into the housing of the electrical connector.

A need exists for an electrical contact assembly which can be inserted in numerous quantities into an electrical connector, both of which are configured to reduce manufacturing and assembly costs.

### SUMMARY

The present disclosure relates to an electrical contact assembly which can be inserted in numerous quantities into an electrical connector, both of which are configured to reduce manufacturing and assembly costs.

The present disclosure also relates to an electrical connector assembly which includes a housing and a plurality of substantially identical contact assemblies arranged in a linear array and in a reverse alternating sequence within the housing such that each successive contact assembly in the array has a reverse orientation with respect to an immediately preceding contact assembly.

In one embodiment, an electrical contact assembly includes a first electrical contact and a second electrical contact. The first electrical contact has an edge connector portion, and a receptacle contact portion in electrical communication with the edge connector portion. Similarly, the second electrical contact has an edge connector portion, and a receptacle contact portion in electrical communication with the edge connector portion. The edge connector portion of the first electrical contact is substantially a mirror image of the edge connector portion of the second electrical contact, while the receptacle contact portion of the first electrical contact is substantially a slide-along image of the receptacle contact portion of the second electrical contact. The first and second electrical contacts may each include an extending portion extending from the edge connector portion, with the extending portion providing the electrical communication between the edge connector portion and the receptacle contact portion. The extending portion of the first electrical contact may be substantially a mirror image of the extending portion of the second electrical contact. The electrical contact assembly may further include a joining member joining the first electrical contact to the second electrical contact. The joining member may further include a recess for mating to a surface of the housing of the electrical connector.

In another embodiment, an electrical connector assembly includes a housing which is configured to receive at least one set of substantially identical electrical contact assemblies arranged in a linear array and in a reverse alternating sequence within the housing such that each successive contact assembly in the array has a reverse orientation with respect to an immediately preceding contact assembly. In one embodiment, the housing includes at least one set of the substantially identical electrical contact assemblies arranged in a linear array and in a reverse alternating sequence within the housing such that each successive contact assembly in the array has a reverse orientation with respect to an immediately preceding contact assembly. Each contact assembly may include a pair of electrical contacts with receptacle contact portions configured to be received by the housing.

The substantially identical electrical contact assemblies may each include a first electrical contact and a second electrical contact. The first electrical contact may have an edge connector portion, and a receptacle contact portion in electrical communication with the edge connector portion. Similarly, the second electrical contact may have an edge connector portion, and a receptacle contact portion in electrical communication with the edge connector portion. The edge connector portion of the first electrical contact is substantially a mirror image of the edge connector portion of the second electrical contact, while the receptacle contact portion of the first electrical contact is substantially a slide-along image of the receptacle contact portion of the second electrical contact. The first and second electrical contacts may each include an extending portion extending from the edge connector portion. The extending portion provides the electrical communication between the edge connector portion and the receptacle contact portion. The electrical connector assembly may further include a joining member joining the first electrical contact to the second electrical contact. The joining member may further include a recess for mating to a surface of the housing.

The housing may be configured to receive the plurality of substantially identical electrical contact assemblies via an array of partitioned electrically insulating adjacent compartments. The electrical connector assembly includes the housing holding a plurality of the identical contact assemblies arranged in a linear array and in a reverse alternating sequence such that each successive contact assembly in the array has a reverse orientation with respect to an orientation of an immediately preceding contact assembly.

The housing may include first and second apertures providing accessibility to the array of compartments. The compartments of the array may be configured to expose the receptacle contact portions of the first and second electrical contacts at the first aperture. The plurality of contact assemblies being arranged in a linear array and in a reverse orientation with respect to the orientation of an immediately preceding contact assembly may expose the receptacle contact portions of the electrically contact assemblies in a staggered configuration with respect to the immediately preceding contact assembly. The compartments of the array may be configured to expose the edge connector portions of the first and second electrical contacts at the second aperture. The present disclosure relates also to a method of manufacturing an electrical contact assembly. The method includes the steps of: providing a carrier strip, and stamping the carrier strip to form at least a first electrical contact assembly. The at least first electrical contact assembly includes a first electrical contact and a second electrical contact. The first electrical contact has an edge connector portion, and a receptacle contact portion in electrical communication with the edge connector portion. Similarly, the second electrical contact has an edge connector portion, and a receptacle contact portion in electrical communication with the edge connector portion. The edge connector portion of the first electrical contact is substantially a mirror image of the edge connector portion of the second electrical contact, while the receptacle contact portion of the first electrical contact is substantially a slide-along image of the receptacle contact portion of the second electrical contact. The first and second electrical contacts may each include an extending portion extending from the edge connector portion, the extending portion providing the electrical communication between the edge connector portion and the receptacle contact portion. The extending portion of the first electrical contact is substantially a mirror image of the extending portion of the second electrical contact. The method of manufacturing may further include the step of joining the first electrical contact together with the second electrical contact to form the at least first electrical contact assembly. The step of joining the first electrical contact together with the second electrical contact may be implemented by forming an overmolding over the first and second electrical contacts.

### BRIEF DESCRIPTION OF THE DRAWINGS

FIG. 1 is a side view of two pairs of electrical contacts for a set of electrical contact assemblies according to the present disclosure;

FIG. 2 is a side view of a set of two electrical contact assemblies according to the present disclosure;

FIG. 3 is a perspective view of a set of electrical contact assemblies being inserted into an electrical connector assembly according to the present disclosure;

FIG. 4 is an enlarged partial perspective view of the electrical contact assemblies inserted into a top surface of the electrical connector assembly according to the present disclosure;

FIG. 5 is full perspective view of the electrical contact assemblies inserted into a top surface of the electrical connector assembly as illustrated in FIG. 4;

FIG. 6 is a perspective view of the electrical contact assemblies inserted into a bottom surface of the electrical connector assembly according to the present disclosure;

FIG. 7 is a perspective view of the end of the electrical connector assembly showing the electrical contact assemblies taken along cross-section line 7-7 of FIG. 6;

FIG. 8 is a plan view of a carrier strip during a portion of a manufacturing method for manufacturing multiple pairs of electrical contact assemblies according to the present disclosure; and

FIG. 9 is a plan view of the carrier strip during another portion of a manufacturing method for manufacturing multiple pairs of electrical contact assemblies according to the present disclosure.

### DETAILED DESCRIPTION

The present disclosure will be understood more fully from the detailed description given below and from the accompanying drawings of particular embodiments of the disclosure which, however, should not be taken to limit the disclosure to a specific embodiment but are for explanatory purposes.

Numerous specific details may be set forth herein to provide a thorough understanding of a number of possible embodiments of the present disclosure. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments disclosed herein are not necessarily limited in this context.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Embodiments of the presently disclosed electrical connector will now be described in detail with reference to the drawing figures wherein like reference numerals identify similar or identical elements. As used herein and as is traditional, the term “distal” refers to that portion which is furthest from the user while the term “proximal” refers to that portion which is closest to the user. In addition, terms such as “above”, “below”, “forward”, “rearward”, etc. refer to the orientation of the figures or the direction of components and are simply used for convenience of description.

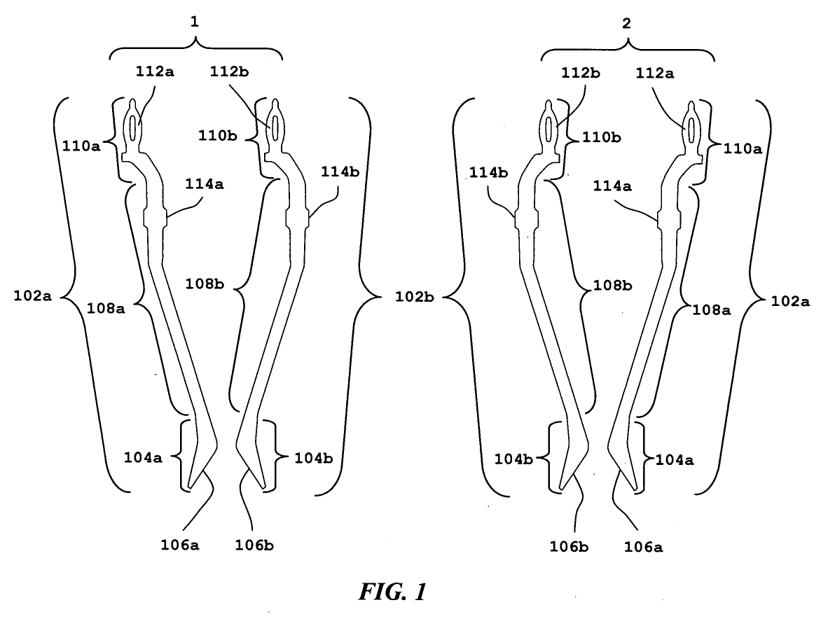

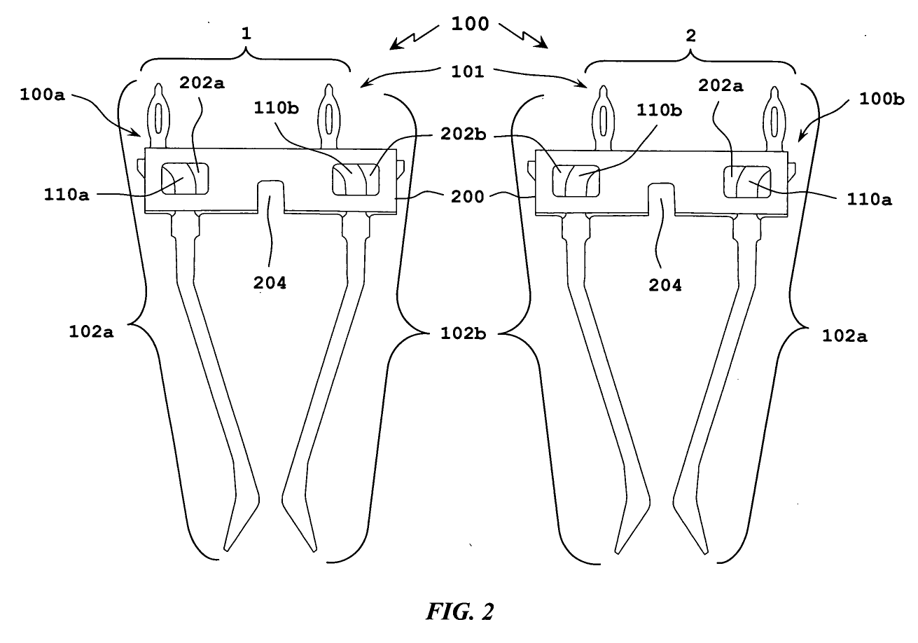

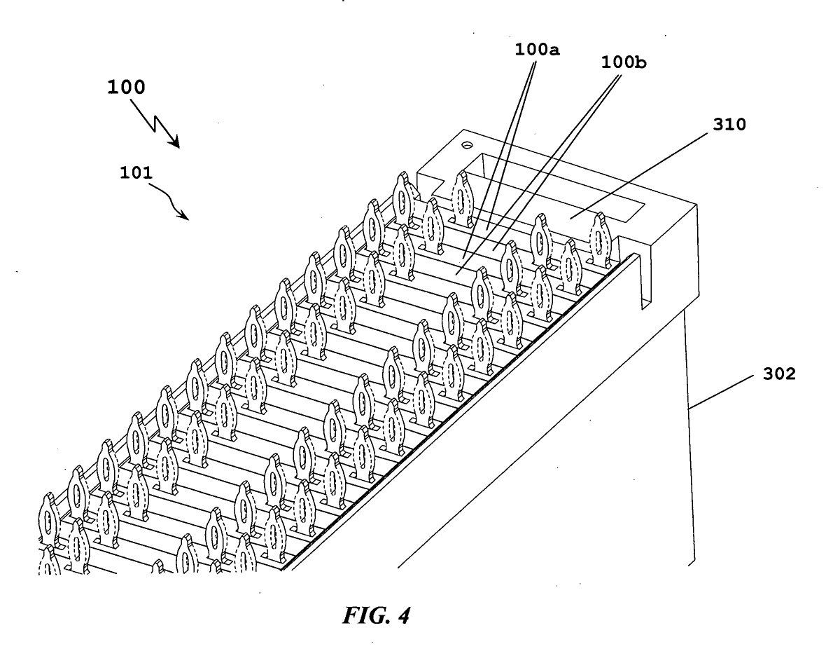

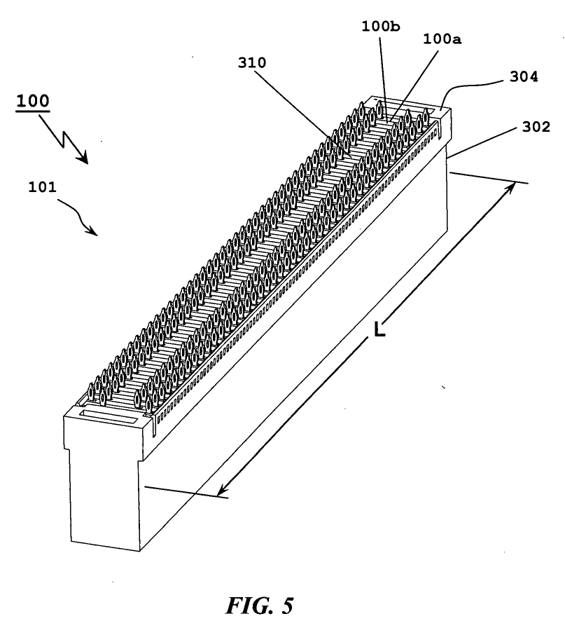

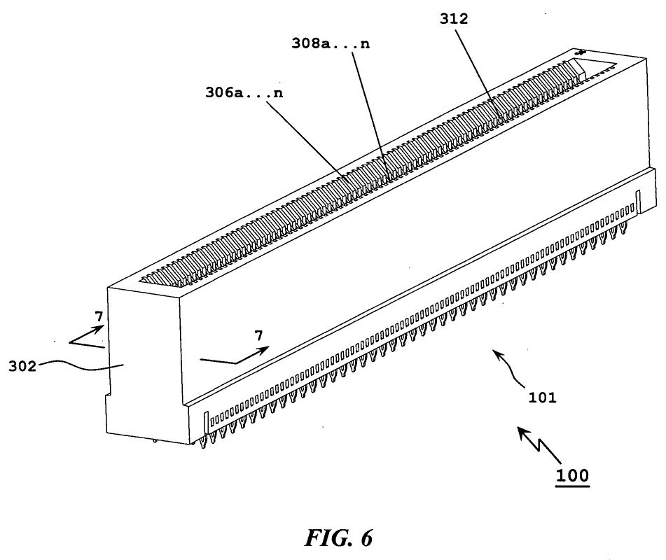

Referring to FIGS. 1-6, a plurality of sets 101 of substantially identical electrical contact assemblies according to an embodiment of the present disclosure are generally designated as 100. Each set 101 of electrical contact assemblies 100 includes a first pair 1 having a first electrical contact 102a and a second electrical contact 102b. The first pair 1 is arranged in a first orientation 100a. Each set 101 of substantially identical electrical contact assemblies 100 further includes a second pair 2 also having first electrical contact 102a and second electrical contact 102b. The second pair 2 is arranged in a second orientation 100b. As illustrated in FIGS. 1 and 2, the first pair 1 is arranged as a mirror image of the second pair 2. More particularly, the first pair 1 and the second pair 2 are rotated with respect to each other so that the orientation 100b of the second pair 2 is a reverse orientation with respect to the orientation 100a of the first pair 1.

The first and second electrical contacts 102a and 102b each include an edge connector portion 104a, 104b having a contact surface 106a, 106b, respectively. The first and second electrical contacts 102a, 102b each include a receptacle contact or press fit tail portion 110a, 110b, respectively. The receptacle contact portion 110a, 110b is in electrical communication with the edge connector portion 104a, 104b, respectively. The first and second electrical contacts 102a, 102b may each include an extending or contact beam portion 108a, 108b which may be predominantly linear and which extends from the edge connector portion 104a, 104b to the receptacle contact or press fit tail portion 110a, 110b, respectively. A manufacturing cut-off region 114a, 114b may be included within the extending or contact beam portion 108a, 108b, respectively. The extending or contact beam portion 108a, 108b is in electrical communication with the edge connector portion 104a, 104b and with the receptacle contact portion 110a, 110b.

The receptacle contact portions 110a, 110b are illustrated in FIG. 1 as compliant or press fit tail portions each of which has an aperture 112a, 112b disposed therethrough, respectively, which is compressed during insertion into a receptacle (not shown) of a printed circuit board (PCB) or other electrical device to establish electrical continuity with the PCB or other electrical device. The receptacle contact portions 110a, 110b may also include card edge contacts or pin or post contacts, or the like. The embodiments are not limited in this context.

The edge connector portion 104a of the first electrical contact 102a is substantially a mirror image of the edge connector portion 104b of the second electrical contact 102b. Similarly, the extending or contact mating beam portion 108a of the first electrical contact 102a is substantially a mirror image of the extending or contact mating beam portion 108b of the second electrical contact 102b. However, the receptacle contact or press fit tail portion 110a of the first electrical contact 102a is substantially a slide-along image of the receptacle contact or press fit tail portion 110b of the second electrical contact 102b.

The electrical contact assembly 100 further includes a joining member 200 joining the first electrical contact 102a to the second electrical contact 102b such that the receptacle contact portion 110a of the first electrical contact 102a is oriented substantially as a slide-along image of the receptacle contact portion 110b of the second electrical contact 102b.

In one embodiment, the joining member 200 joins the extending or contact beam portion 108a of the first electrical contact 102a to the extending or contact beam portion 108b of the second electrical contact 102b such that the receptacle contact portion 110a of the first electrical contact 102a is oriented substantially as a slide-along image of the receptacle contact portion 110b of the second electrical contact 102b. The joining member 200 may be a structural member such as an overmolding which may be made from an electrically insulating material such as a plastic, and which enables electrical insulation between the first and second electrical contacts 102a and 102b, respectively. The embodiments are not limited in this context.

The joining member 200 is configured such that the receptacle contact portions 110a, 110b are exposed thereby. In one embodiment, the joining member 200 may further include a recess 204 for mating to a surface of a housing of an electrical connector as discussed below. In addition, the overmolding or joining member 200 may further include at least one aperture, and typically at least two apertures 202a, 202b, disposed therethrough so as to expose at least a portion of the extending or contact mating beam portions 108a and 108b, respectively.

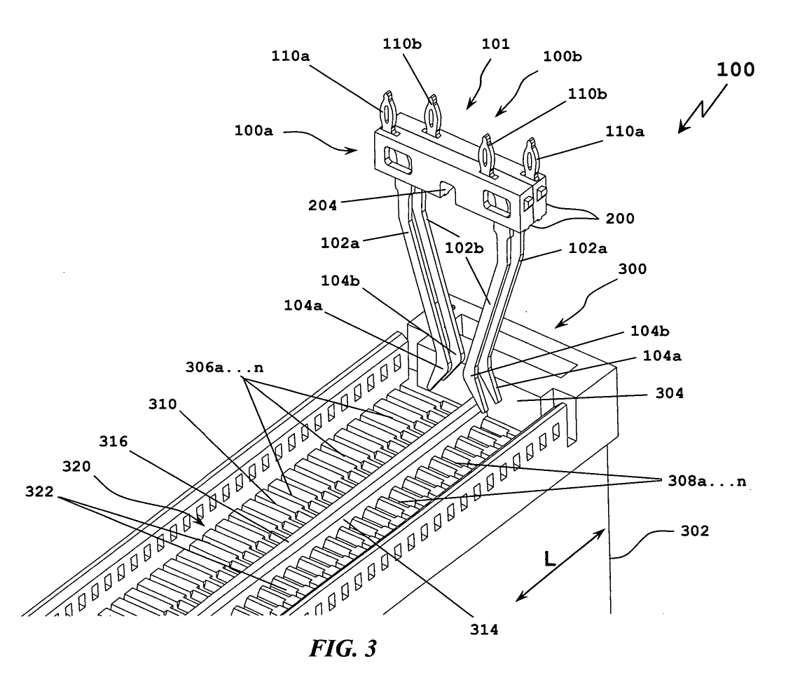

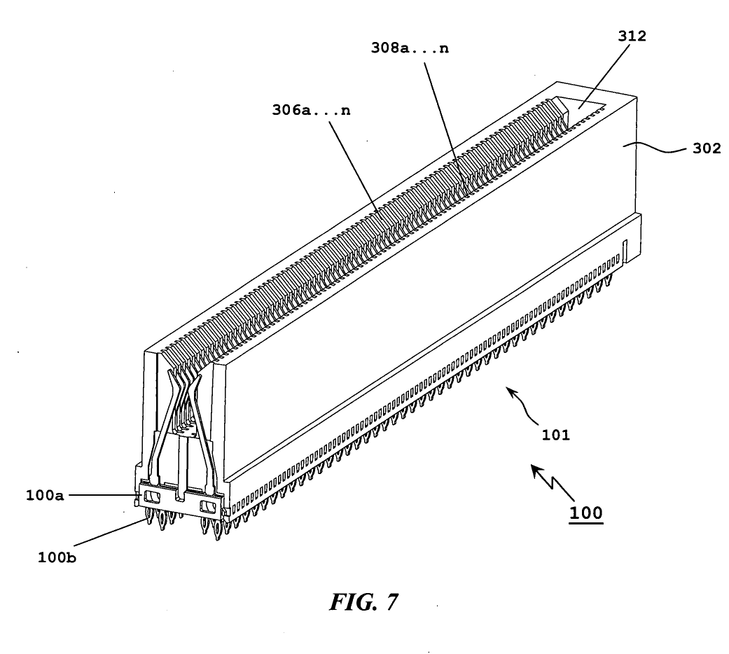

As illustrated in FIGS. 3-7, the present disclosure relates also to an electrical connector or electrical connector assembly 300 including a housing 302. The housing 302 includes first and second apertures 310 and 312 providing accessibility to an array of compartments 320. The housing 302 is configured to receive at least one set 101 of the substantially identical electrical contact assemblies 100 via the array 320 of partitioned electrically insulating adjacent compartments 322. The array 320 of partitioned compartments is subdivided into a first array 306a . . . n and a second array 308a . . . n which are electrically and mechanically separated from each other via a wall or partition 314 disposed substantially centrally along a length L of the housing 302, where “a” equals one and “n” equals a number greater than one. The wall or partition 314 includes a ridge or saddle member 316 also disposed substantially centrally along the length L. The recess 204 of the overmolding 200 engages with the ridge or saddle member 316 to provide a degree of stability for the electrical contact assemblies 100 when the electrical contact assemblies 100 are received by the housing 302.

The compartments 322 of the array 320 are configured to expose the receptacle contact portions 110a, 110b of the first and second electrical contacts 102a, 102b at the first aperture 310. As illustrated particularly in FIGS. 3-7, a plurality of contact assemblies 100 are arranged in sets 101 in sequence in a linear array such that the electrical contacts 102a, 102b of the plurality of contact assemblies 100 are arranged in the second orientation 100b which is a reverse orientation with respect to the first orientation 100a of an immediately preceding contact assembly 100 so as to expose the receptacle contact portions 110a, 110b of the electrical contact assemblies 100 in a staggered configuration with respect to the receptacle contact portions 110b, 110a of the immediately preceding contact assembly, respectively. The compartments 322 of the array 320 are configured to expose the edge connector portions 104a, 104b of the first and second electrical contacts 102a, 102b at the second aperture 312.

As a result of the foregoing, the electrical connector assembly 300 includes the housing 302, and at least one set 101 of substantially identical contact assemblies 100. In one embodiment, the housing 302 includes a plurality of the substantially identical contact assemblies 100. Each contact assembly 100 includes at least one of the pairs 1 or 2 of electrical contacts 102a, 102b with the receptacle contact portions 110a, 110b configured to be received by the housing 302. The plurality of contact assemblies 100 are arranged in sequence in a linear array in the housing 302. Each contact assembly 100 is arranged in the sequence in alternating first and second orientations 100a, 100b, respectively. The second orientation 100b is a reverse orientation with respect to the first orientation 100a.

Furthermore, the electrical connector assembly 300 includes the housing 302 holding a plurality of the sets 101 of identical contact assemblies 100 arranged in a linear array and in a reverse alternating sequence such that each successive contact assembly 100 in the array has a reverse orientation 100b with respect to an orientation 100a of an immediately preceding contact assembly 100.

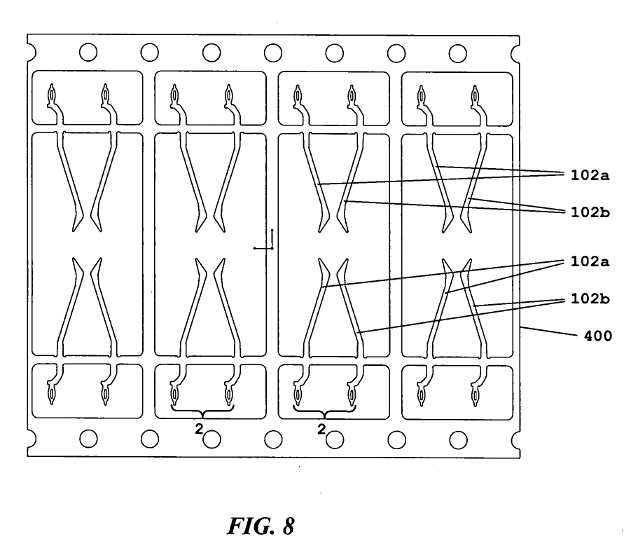

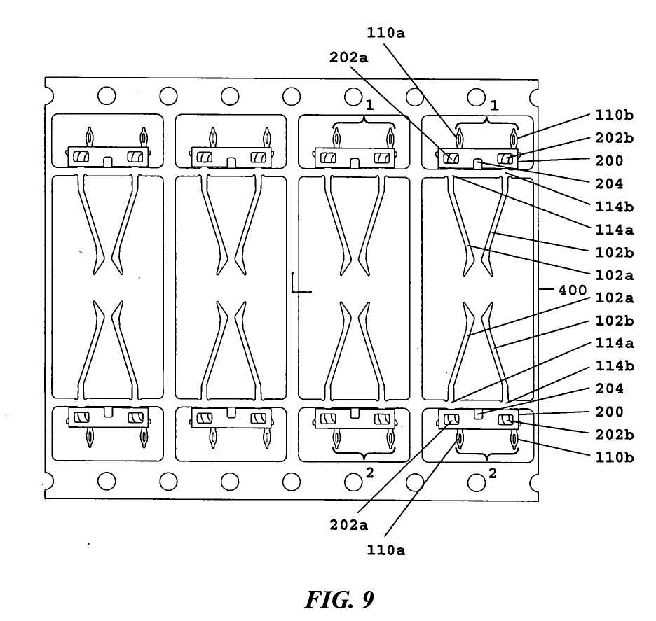

FIGS. 8-9 disclose a method of manufacturing the electrical contact assembly 100. In particular, as illustrated in FIG. 8, the method includes the steps of providing a carrier strip 400, and stamping the carrier strip 400 to form at least a first electrical contact assembly 100. In one embodiment, the step of stamping the carrier strip is implemented by forming a multiplicity of the electrical contact assemblies 100. Each electrical contact assembly 100 includes first electrical contact 102a and second electrical contact 102b. The first electrical contact 102a is configured so that receptacle contact portion 110a is in electrical communication with the edge connector portion 104a (shown in FIG. 1). Similarly, the second electrical contact 102b is configured so that receptacle contact portion 110b is in electrical communication with the edge connector portion 104b. The first and second electrical contacts 102a and 102b are made from an electrically conductive material to provide electrical communication between the edge connector portions 104a, 104b and the receptacle contact portions 110a, 110b, respectively.

The edge connector portion 104a of the first electrical contact 102a is substantially a mirror image of the edge connector portion 104b of the second electrical contact 102b, while the receptacle contact portion 110a of the first electrical contact 102a is substantially a slide-along image of the receptacle contact portion 110b of the second electrical contact 102b. In one embodiment of the method, the first and second electrical contacts 102a and 102b, respectively, each include a contact beam or extending portion 108a and 108b (shown in FIG. 1), respectively, extending from the edge connector portion 104a, 104b, respectively. The extending portion 108a, 108b may provide the electrical communication between the edge connector portion 104a, 104b and the receptacle contact portion 110a, 110b, respectively. The extending portion 108a of the first electrical contact 102a may be substantially a mirror image of the extending portion 108b of the second electrical contact 102b.

The method of manufacturing may further include the step of joining the first electrical contact 102a together with the second electrical contact 102b to form an electrical contact assembly 100. In one embodiment, the step of joining the first electrical contact 102a together with the second electrical contact 102b is implemented by forming overmolding 200 over the first and second electrical contacts 102a and 102b, respectively. The overmolding 200 enables electrical insulation between the first and second electrical contacts 102a and 102b, respectively. In one embodiment, the method of manufacturing may further include the step of cutting the first electrical contact assembly 100 from the carrier strip 400 via the manufacturing cut-offs 114a and 114b. The method may further include the step of providing a recess 204 in the joining member or overmolding 200 for mating to ridge or saddle member 316 of the housing 302. The method of manufacturing may further include the step of providing at least one aperture 202a, and typically at least two apertures 202a and 202b disposed through the joining member or overmolding 200 so as to expose at least a portion of the receptacle contact portions 110a, 110b.

As can be appreciated from the foregoing disclosure, the embodiments of the present disclosure provide an electrical contact assembly which can be inserted in numerous quantities into an electrical connector, both of which are configured to reduce manufacturing and assembly costs. The disposition of the receptacle contact portions in a staggered configuration enables a savings in space for electrically communicating or mating to an electrical device which is intended to receive the receptacle contact portions.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. An electrical contact assembly comprising:
a first electrical contact and a second electrical contact,
the first electrical contact having:
an edge connector portion; and
a receptacle contact portion in electrical communication with the edge connector portion,
the second electrical contact having:
an edge connector portion; and
a receptacle contact portion in electrical communication with the edge connector portion,
wherein the edge connector portion of the first electrical contact is substantially a mirror image of the edge connector portion of the second electrical contact, and
wherein the receptacle contact portion of the first electrical contact is substantially a slide-along image of the receptacle contact portion of the second electrical contact.

2. The electrical contact assembly according to claim 1, wherein the first and second electrical contacts each comprise an extending portion extending from the edge connector portion, the extending portion providing the electrical communication between the edge connector portion and the receptacle contact portion.

3. The electrical contact assembly according to claim 2, wherein the extending portion of the first electrical contact is substantially a mirror image of the extending portion of the second electrical contact.

4. The electrical contact assembly according to claim 1, further comprising:
a joining member joining the first electrical contact to the second electrical contact.

5. The electrical contact assembly according to claim 4, wherein the joining member further comprises a recess for mating to a surface of a housing of an electrical connector.

6. An electrical connector assembly comprising:
a housing configured to receive at least one set of substantially identical electrical contact assemblies arranged in a linear array along a longitudinal axis of the housing and in a reverse alternating sequence such that each successive contact assembly in the array has a reverse orientation with respect to an immediately preceding contact assembly.

7. The electrical connector assembly according to claim 6, wherein the housing comprises at least one set of substantially identical electrical contact assemblies arranged in a linear array and in a reverse alternating sequence such that each successive contact assembly in the array has a reverse orientation with respect to an immediately preceding contact assembly, and wherein the substantially identical electrical contact assemblies each comprise:
a first electrical contact and a second electrical contact,
the first electrical contact having:
an edge connector portion; and
a receptacle contact portion in electrical communication with the edge connector portion,
the second electrical contact having:
an edge connector portion; and
a receptacle contact portion in electrical communication with the edge connector portion,
wherein the edge connector portion of the first electrical contact is substantially a mirror image of the edge connector portion of the second electrical contact, and
wherein the receptacle contact portion of the first electrical contact is substantially a slide-along image of the receptacle contact portion of the second electrical contact.

8. The electrical connector assembly according to claim 7, wherein the first and second electrical contacts each comprise an extending portion extending from the edge connector portion, the extending portion providing the electrical communication between the edge connector portion and the receptacle contact portion.

9. The electrical connector assembly according to claim 7, further comprising:
a joining member joining the first electrical contact to the second electrical contact.

10. The electrical connector assembly according to claim 9, wherein the joining member further comprises a recess for mating to a surface of the housing.

11. The electrical connector assembly according to claim 7, wherein the housing is configured to receive the at least one set of substantially identical electrical contact assemblies via an array of partitioned electrically insulating adjacent compartments.

12. The electrical connector assembly according to claim 11, wherein the housing comprises first and second apertures providing accessibility to the array of compartments.

13. The electrical connector assembly according to claim 12, wherein the compartments of the array are configured to expose the receptacle contact portions of the first and second electrical contacts at the first aperture.

14. The electrical connector assembly according to claim 13, wherein the at least one set of substantially identical electrical contact assemblies exposes the receptacle contact portions of the electrical contact assemblies in a staggered configuration.

15. The electrical connector assembly according to claim 12, wherein the compartments of the array are configured to expose the edge connector portions of the first and second electrical contacts at the second aperture.

16. An electrical connector assembly comprising:
a housing holding a plurality of substantially identical electrical contact assemblies in a linear array along a longitudinal axis of the housing and in a reverse alternating sequence such that each successive contact assembly in the array has a reverse orientation with respect to an immediately preceding contact assembly.

17. A method of manufacturing an electrical contact assembly, the method comprising the steps of:
providing a carrier strip; and
stamping the carrier strip to form at least a first electrical contact assembly, the at least first electrical contact assembly including a first electrical contact and a second electrical contact,
the first electrical contact having:
an edge connector portion; and
a receptacle contact portion in electrical communication with the edge connector portion,
the second electrical contact having:
an edge connector portion; and
a receptacle contact portion in electrical communication with the edge connector portion,
wherein the edge connector portion of the first electrical contact is substantially a mirror image of the edge connector portion of the second electrical contact, and
wherein the receptacle contact portion of the first electrical contact is substantially a slide-along image of the receptacle contact portion of the second electrical contact.

18. The method of manufacturing according to claim 17, wherein the first and second electrical contacts each comprise an extending portion extending from the edge connector portion, the extending portion providing the electrical communication between the edge connector portion and the receptacle contact portion.

19. The method of manufacturing according to claim 18, wherein the extending portion of the first electrical contact is substantially a mirror image of the extending portion of the second electrical contact.

20. The method of manufacturing according to claim 17, further comprising the step of:
joining the first electrical contact together with the second electrical contact to form the at least first electrical contact assembly.

21. The method of manufacturing according to claim 20, wherein the step of joining the first electrical contact together with the second electrical contact is implemented by forming an overmolding over the first and second electrical contacts.
